(19) United States
(12) Patent Application Publication
(10) Pub. No.: US 2008/0042973 A1
(43) Pub. Date: Feb. 21, 2008

(54) System for sensing yaw rate using a magnetic field sensor and portable electronic devices using the same

(75) Inventors: Yang Zhao, Andover, MA (US); Xiafeng Lei, Jiangsu (CN)

Correspondence Address: WEINGARTEN, SCHURGIN, GAGNEBIN & LEBOVICI LLP, TEN POST OFFICE SQUARE, BOSTON, MA, 02109, US

(73) Assignee: MEMSIC, INC.

(21) Appl. No.: 11/825,993

(22) Filed: Jul. 10, 2007

Related U.S. Application Data
(60) Provisional application No. 60/819,735, filed on Jul. 10, 2006.
(60) Provisional application No. 60/906,100, filed on Mar. 9, 2007.

(51) Int. Cl. G01P 15/105; G09G 5/00

(52) U.S. Cl. 345/156; 715/863

(57) ABSTRACT

An attitude- and motion-sensing system for an electronic device, such as a cellular telephone, a game device, and the like, is disclosed. The system, which can be integrated into the portable electronic device, includes a two- or three-axis accelerometer and a three-axis magnetic compass. Data about the attitude of the electronic device from the accelerometer and magnetic compass are first processed by a signal processing unit that calculates attitude angles (pitch, roll, and yaw) and rotational angular velocities. These data are then translated into input signals for a specific application program associated with the electronic device.

### CROSS REFERENCE TO RELATED APPLICATIONS

Priority of Provisional Patent Application No. 60/819,735 dated Jul. 10, 2006, entitled “Yaw Rate Sensing by Using Magnetic Field Sensor(Compass)—Replacing Gyro Function with a Compass”, and Provisional Patent Application No. 60/906,100 dated Mar. 9, 2007, entitled “Motion and Attitude Sensing for Portable Electronic Devices” is claimed.

### STATEMENT REGARDING FEDERALLY SPONSORED RESEARCH OR DEVELOPMENT

### N/A

### FIELD OF THE INVENTION

The present invention relates to input technology for electronic devices and, more particularly, to an electronic device or apparatus that is adapted to generate input signals corresponding to its attitude or change in attitude to an application program being executed on the electronic device itself.

### BACKGROUND OF THE INVENTION

Portable devices and especially, although not exclusively, portable wireless devices, e.g., mobile telephones, cellular telephones, cordless telephones, text messaging devices, pagers, talk radios, portable navigation systems, portable music players, portable video players, portable multimedia devices, personal digital assistants (PDAs), portable games, and the like, are being used increasingly in everyday life. As technology advancements are made, portable electronic devices are integrating more and more applications while shrinking in size and weight. Typically, the user interface and the power source comprise most of the volume and weight of the portable device.

The user interface of a portable device and, more particularly, the signal input portion of the user interface, is very important to the operation and operability of the portable device. Conventionally, user command input and data input into portable devices have been performed using input devices such as a keyboard or keypad, a mouse, a joy-stick, a stylus or digital pen or a gesture using the device itself. For scrolling and menu navigation, arrow buttons, thumbwheels, game-handles, and other devices may also be included with the portable devices.

However, as portable devices become more sophisticated and smaller, traditional keypad, arrow button, thumbwheel, or digital pen/stylus entry may be inconvenient, impractical or non-enjoyable if the component parts are too small. More complex menus, three-dimensional maps, and advanced games requiring more sophisticated navigation exacerbate the problem.

The development of motion sensing devices, e.g., motion sensing accelerometers, gravitational accelerometers, gyroscopes, and the like, and their integration into the portable device itself have been suggested by others, to generate input signal data. For example, U.S. Pat. No. 7,138,979 to Robin, et al. discloses methods and systems for generating input signals based on the orientation of the portable device. Robin discloses using cameras, gyroscopes, and/or accelerometers, to detect a change in the spatial orientation of the device and, further, to generate position signals that are indicative of that change. According to Robin, the input signal can be used to move a cursor, to operate a game element, and so forth.

U.S. Patent Application Publication Number 2006/0046848 to Abe, et al. discloses a game suitable for play on a portable device that includes a vibration gyroscope sensor. The vibration gyroscope sensor detects an angular velocity from a change in vibration resulting from Coriolis forces acting in response to the change in orientation. According to the teachings of Abe, the gyroscope sensor detects an angular velocity of rotation about an axis perpendicular to the display screen of the game. From angular velocity data, two-dimensional angle of rotation data are calculated.

Gyroscope sensors disclosed by Robin and Abe, however, are expensive and relatively large in dimension and weight. Robin and Abe also address the two-dimensional “orientation” of a portable device rather than the three-dimensional “attitude” of the portable device. Therefore, it would be desirable to provide methods, devices, and systems for generating input signal data about the three-dimensional attitude of a portable device. It would also be desirable to provide devices and systems for generating input signal data that are more economical, relatively smaller, and relatively lighter than conventional devices with gyroscope sensors.

Conventional attitude-sensing includes a two- or a three-axis accelerometer and a three-axis gyroscope to provide full motion status, i.e., pitch, roll, and yaw. Although accelerometers are becoming less and less expensive, gyroscopes remain several times more expensive than accelerometers due to their technological and manufacturing complexity.

Additionally, in ideal free space, which is to say, under conditions having zero gravity and no magnetic field, six-degree of freedom motion information can be gathered using a two- or three-axis accelerometer and a three-axis gyroscope. However, on Earth, existing gravitational and magnetic field forces prevent ideal free space conditions. As a result, a magnetic field sensing device to replace the gyroscope at much lower cost is desirable.

In consumer applications, when cost is the ultimate important factor, a lower cost solution to fulfill a functional need will be key to successful commercialization. Therefore, it would be desirable to provide an attitude- and motion-sensing device for measuring magnetic field strength and acceleration about or in three orthogonal axes to determine the attitude and the change in attitude of an object in space.

### BRIEF SUMMARY OF THE INVENTION

An attitude- and motion-sensing system for a portable electronic device, such as a cellular telephone, a game device, and the like, is disclosed. The system, which can be integrated into the portable electronic device, includes a two- or three-axis accelerometer and a three-axis magnetic field sensor, such as a magnetic compass. Data about the attitude of the portable electronic device from the accelerometer and magnetic field sensor are first processed by a signal processing unit that calculates attitude angles and rotational angles. These data are then translated into input signals for a specific application program associated with the portable electronic device.

### BRIEF DESCRIPTION OF THE DRAWINGS

The foregoing and other objects, features, and advantages of the invention will be apparent from the following more particular description of preferred embodiments of the invention, as illustrated in the accompanying drawings in which like reference characters refer to the same parts throughout the different views.

FIG. 1 is a diagram illustrating the attitude angles of a rigid object in space in accordance with the prior art;

FIG. 2 is a block diagram illustrating a procedure of input signal generation in accordance with the prior art;

FIG. 3 is a diagram of an apparatus using the present technology in connection with a three-dimensional map application;

FIG. 4 is a diagram of an apparatus using the present technology in connection with a flight simulator gaming application; and

FIG. 5 is a flow chart of a method of providing attitude and change of attitude signals to an application program in accordance with the present invention.

### DETAILED DESCRIPTION

The present invention relates to an attitude-sensing device for sensing the attitude of an object and a motion-sensing device for sensing changes in the attitude of the object. The attitude- and motion-sensing device includes a three-axis magnetic field sensor and a two- or three-axis accelerometer. More particularly, the attitude- and motion-sensing device uses a three-axis magnetic compass and a two- or three-axis accelerometer, to generate input signals for determining the attitude of the object, e.g., the attitude- and motion-sensing device itself.

### Magnetic Field Sensing Device

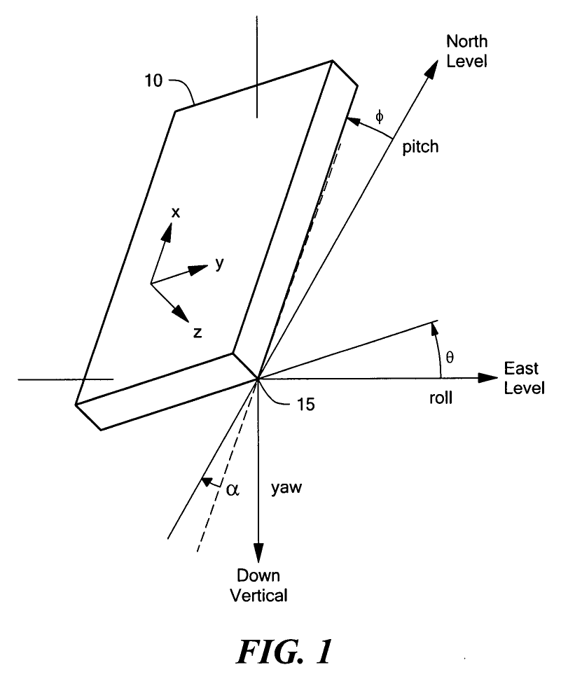

The attitude of a rigid object 10 in space can be described by three angles: yaw, pitch, and roll (see FIG. 1). Typically, these angles are referenced to a local horizontal plane, for example, a plane perpendicular to the Earth's gravitational vector or the ecliptic plane of the Earth. Yaw (α) is defined as an angle measured clockwise in the local horizontal plane from a true North direction, i.e., the Earth's magnetic polar axis, to the forward direction of the object 10. Pitch (Φ) is defined as an angle between the object's longitudinal axis and the local horizontal plane. By convention, in aerospace applications, positive pitch refers to “nose up” and negative pitch refers to “nose down”. Roll (θ) is defined as a rotation angle about the longitudinal axis between the local horizontal plane and the actual plane of the object. By convention, in aerospace applications, positive roll refers to “right wing down” and negative roll refers to “right wing up”.

According to the prior art, three-axis magnetic field sensors, e.g., gyroscopes, can be adapted to measure the magnetic field strength about an X-, a Y-, and a Z-axis, respectively, Mₓ, M_{y}/M_{z}, while three-axis accelerometers can be adapted to measure acceleration in the X-, Y-, and Z-axis, respectively, Aₓ, A_{y}, A_{z}. Thus, the pitch of the object 10 in space is calculated by the formula:

φ=sin⁻¹(−Aₓ/g) (1)

and the roll of the object 10 in space is calculated by the formula:

θ=sin⁻¹[A_{y}/(g·cos φ)] (2)

where g refers to the acceleration of gravity. Accordingly, one can determine both pitch and roll without a magnetic field sensor, using a two- or a three-axis accelerometer to provide Aₓ and A_{y} measurements.

Calculation of yaw is slightly more involved and requires measurement data from both the accelerometer and the magnetic field sensor. More particularly, yaw can be calculated using the following equations:

Mₓₕ=Mₓ·cos φ+M_{y}·sin θ·sin 100 +M_{z}·cos θ·sin φ

M_{yh}=M_{y}·cos θ−M_{z}·sin θ

α=tan⁻¹(M_{yh}/Mₓₕ) (3)

where Mₓₕ refers to the magnetic field strength about the X-axis in the local magnetic plane and M_{yh} refers to the magnetic field strength about the Y-axis in the local magnetic plane. Angular velocity associated with pitch, roll, and yaw can be obtained by calculating the time derivative of the angle change using, respectively, the following equations:

$${ω}_{x} = \frac{d θ}{d t} ; {ω}_{y} = \frac{d φ}{d t} ; {ω}_{z} = \frac{d α}{d t} \qquad ( 4 )$$

where ωₓ, ω_{y}, ω_{z} correspond to the angular velocities of the object's rotation about the X-, Y-, and Z-axis, respectively.

Gyroscopes, traditionally, have been a critical part of inertial attitude sensing systems, providing yaw. However, the present inventors have found that yaw and angular velocity of yaw rotation can be detected using a magnetic compass.

Advantageously, in contrast with gyroscopes, a magnetic compass can sense yaw, pitch, and roll angular rate as well as inertial attitude position. Indeed, gyroscopes do not provide absolute angular position information, but, rather, only provide the relative change of angular position information.

Gyroscopes also tend to be relatively large in comparison with magnetic compasses. For example, a three-axis magnetic compass can be manufactured to be as small or smaller than about 0.2 in.×0.2 in.×0.04 in. (about 5 mm×5 mm×1.2 mm). Three-axis gyroscopes with similar capabilities will be significantly larger.

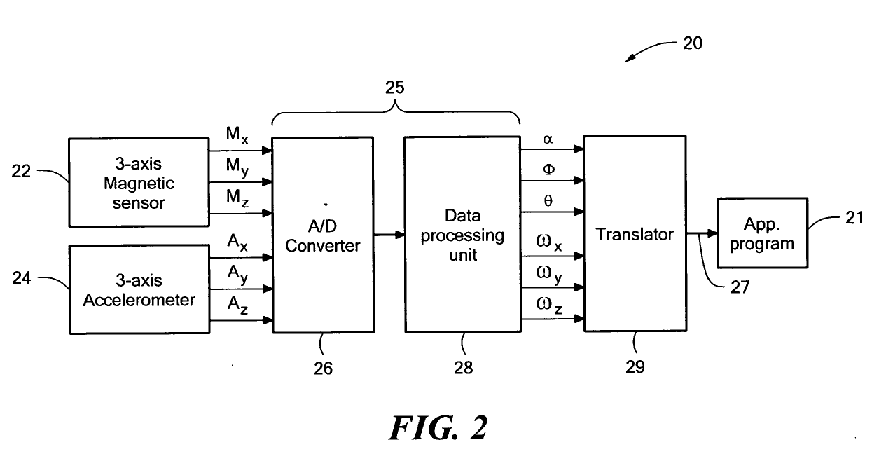

FIG. 2 shows a block diagram of a typical input signal generation system 20. When the attitude of a sensing device(s) 22, 24 changes, which is to say that, the sensing device(s) 22, 24 rotates about at least one of its X-, Y-, and Z-axes, the sensing device(s) 22, 24 generates an output signal that is proportional to the measured magnetic field strengths Mₓ, M_{y}, and M_{z} and to the accelerations Aₓ, A_{y}, and A_{z}. Typically, a magnetic field sensor 22 senses Mₓ, M_{y}, M_{z} and an accelerometer 24 senses Aₓ, A_{y}, A_{z}.

The six magnetic field strength and acceleration parameters are transmitted to a processing unit 25, which can be integrated into one or more of the sensing devices 22, 24 or which can be a separate, local or remote electronic device. The processing unit 25 includes signal and data processing units to process the measured parameter data. For example, the processing unit 25 can include an analog-to-digital (A/D) converter 26 for A/D conversion, a data processing unit 28 for processing data, and the like.

More specifically, the data processing unit 28 can be adapted to use equations (1), (2), (3), and (4) above, to calculate attitude angles, α, Φ, θ, and angular velocities, ox, ω_{y}, ω_{z}. These data can then be input into a translator unit 29 that is adapted to translate the data into an input signal 27. The translated input signal 27 is then transmitted to an electronic processing device 21 that includes an application or driver program for manipulating the translated attitude angle and angular velocity data into motion status.

Even in conditions of non-zero gravity, roll and pitch and roll and pitch angular rotation can be calculated using the tilt of the accelerometer in X- and Y-directions and using Equations (1) and (2) above.

### Exemplary Uses of the Technology

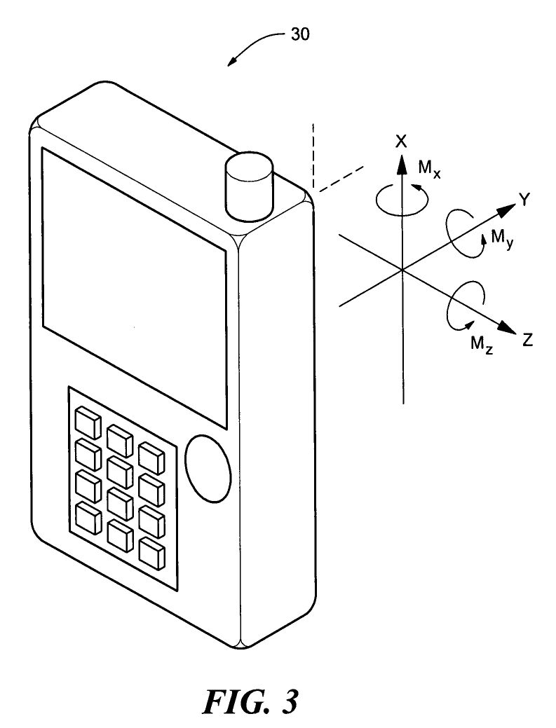

An application of a magnetic compass in a cellular telephone 30 is shown in FIG. 3. For the purpose of this disclosure, the cellular telephone 30 is further adapted to execute a three-dimensional (3D) map program and to allow users to rotate the cellular telephone (and therefore the virtual map) about all three axes. Conventional cellular telephones with or without gyroscopes or magnetic field sensing would require at least six input devices, e.g., buttons, to accomplish the input signal generation: two buttons for X-axis rotation, two buttons for Y-axis rotation, and two buttons for Z-axis rotation.

With a magnetic compass as a magnetic field sensing device, however, direction-arrow buttons are not needed. More specifically, with a magnetic compass, as the cellular telephone 30 is rotated, the pitch, roll, and yaw (α, Φ and θ) are obtained. These sensor signals can be processed to provide attitude angles (α, Φ and θ) and angular velocities (ωₓ, ω_{y}, ω_{z}). The attitude angles and angular velocities can be input into the translator 29, which translates the attitude angles and angular velocities into appropriate input signals 27 to the application program 21.

In short, input signal 27 generation does not require direction-arrow buttons; but, rather, one simply changes the attitude of the cellular telephone 30 to produce sensor signals, e.g., Mₓ, M_{y}, M_{z}, Aₓ, A_{y}, and A_{z}. When the application program is a 3D map application, map rotation about three axes is possible. Advantageously, the panel surface area that would be needed for the conventional navigation buttons is not needed. Consequently, the surface area that otherwise would have been used for navigation buttons can be used for another purpose and/or the cellular telephone 30 can be made smaller.

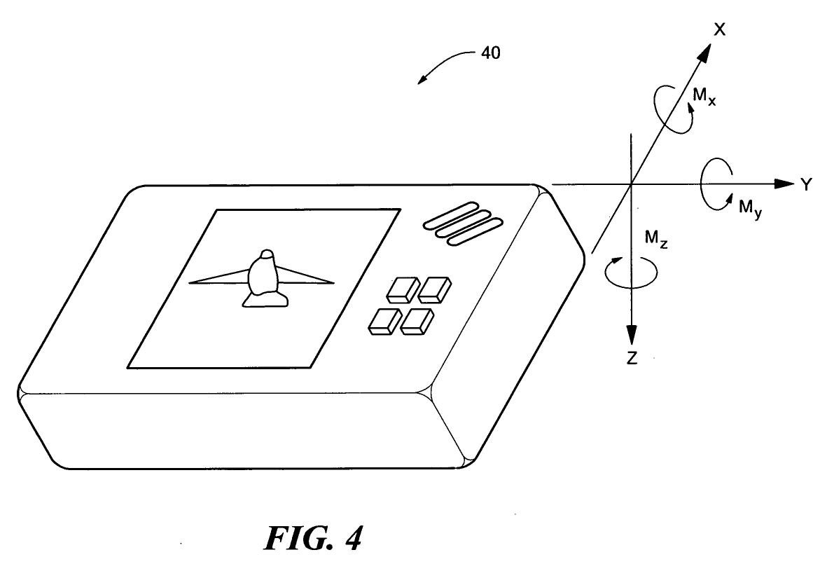

An application for a flight simulator game executable on a portable game machine 40 is shown in FIG. 4. Although for the purposes of this embodiment, the game machine 40 will be a flight simulator, those of ordinary skill in the art can appreciate the applicability of the teachings of the present invention to a myriad of game machines 40 and gaming programs that involve three dimensions and attitude control.

A conventional game machine for controlling the attitude of an airplane requires numerous input devices, e.g., buttons, on the surface of the game device or, alternatively, a joystick that is operatively coupled to the gaming device. In contrast, according to the present invention, with a combination of a magnetic compass and an accelerometer, rotating the gaming machine itself along one or more of its X-, Y-, and/or Z-axis generates airplane attitude input signals that can be used to control the airplane's attitude.

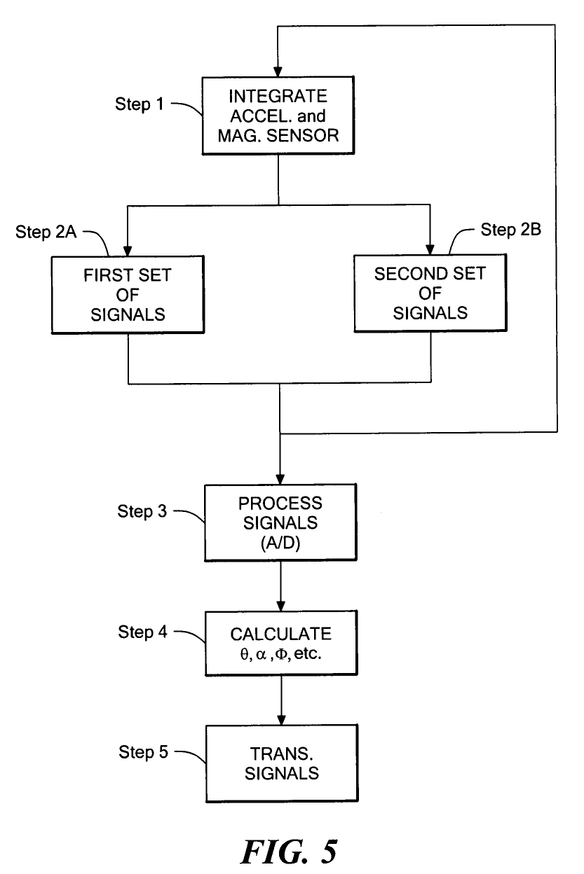

Having described systems for motion- and attitude sensing and portable electronic devices having such systems, methods for providing attitude and change in attitude input signals to an application program; for determining the inertial attitude and change in inertial attitude of an object and for changing an operation performed on an application program executed by the object; and for generating input signals to an application program that is executable on a portable electronic device will now be described. Referring to the flow chart in FIG. 5 and FIG. 2, the methods include integrating a two- or three-axis accelerometer and a three-axis magnetic field sensor into the portable electronic device (STEP 1) and, further, adapting the two- or three-axis accelerometer to produce a first set of signals (STEP 2A) and adapting the three-axis magnetic field sensor, e.g., a magnetic compass, to produce a second set of signals (STEP 2B).

The first set of signals produced by the two- or three-axis accelerometer (STEP 2A) correspond to accelerations and/or changes in acceleration in the X-, Y-, and Z-directions, Aₓ, A_{y}, A_{z}, which are proportional to changes in the inertial attitude of the portable electronic device. Similarly, the second set of signals produced by the three-axis magnetic field sensor (STEP 2B) correspond to the magnetic field strength and/or changes in the magnetic field strength about the X-, Y-, and Z-axes, Mₓ, M_{y}, M_{z}, which also are proportional to changes in the inertial attitude of the portable electronic device.

The first and second sets of signals are then processed (STEP 3), which can include, without limitation, converting analog signals to digital signals using an A/D converter. The digital signals can then be processed, e.g., through a processing unit, to calculate one or more of pitch, yaw, roll, which is to say, the inertial attitude of the device and/or changes thereto, and the angular rotation about the X-, Y-, and/or Z-axis (STEP 4) and/or changes thereto.

The calculated pitch, yaw, roll, and/or angular rotations are then translated into input signals that are compatible with an application program being executed on or executable by the portable electronic device (STEP 5). More particularly, the calculated pitch, yaw, roll, and/or angular rotations are translated into input signals that change an operation on the application program.

For example, in use in conjunction with 3D image manipulation, the accelerations and magnetic field strengths can first be calculated and then be adapted to describe the 3D image's movement and displacement along and or rotation about the X-, Y- and/or Z-axis. Thus, when the portable electronic device is rotated about one or more of its inertial axes, some or all of the accelerations and magnetic field strengths will be changes, which translates into changes in pitch, yaw, roll, and/or in angular rotation. When these changes are translated and input into the application program being executed on the portable electronic device, the 3D image is moved proportional to the input signals from the rotated portable electronic device.

Application of the present invention, however, is not limited to portable devices. Indeed, the present invention is applicable to any electronic device, whether portable or not, having a human-machine, i.e., user, interface. For example, those of ordinary skill in the art can adapt the pitch, yaw, and roll functions of the present invention for use with a mouse to generate input signals to a personal computer; a remote controller to generate signals to a host device, such as, without limitation, a television, a radio, a DVD player, a stereo system or other multi-media device and an electronic instrument, e.g., an electronic piano or organ.

The foregoing description is not intended to be exhaustive or to limit the invention to the precise form disclosed. The embodiment was chosen and described to provide the illustration of principles of the invention and its application. Modification and variations are within the scope of invention.

What is claimed is:

1. A motion- and attitude-sensing system integrated into an electronic device having an application program that is executable on the electronic device, the system comprising:
a three-axis accelerometer that is adapted to provide a first set of signals associated with a change in attitude of the electronic device; and
a three-axis magnetic field sensor that is adapted to provide a second set of signals associated with a change in attitude of the electronic device,
wherein the three-axis magnetic field sensor is a magnetic compass.

2. The motion- and attitude-sensing system as recited in claim 1 further comprising a signal processing unit for processing the first and second sets of signals to provide attitude angle and rotational angle velocity signal data, the signal processing unit comprising:
a data processing unit that is adapted to calculate a pitch angle, a roll angle, a yaw angle, an angular rotation about an X-axis, an angular rotation about an Y-axis, and an angular rotation about an Z-axis from said first and second sets of signals.

3. The motion- and attitude-sensing system as recited in claim 2, wherein the signal processing unit further comprises an analog-to-digital converter.

4. The motion- and attitude-sensing system as recited in claim 2 further comprising a translator that is adapted to translate the pitch angle, the roll angle, the yaw angle, the angular rotation about the X-axis, the angular rotation about the Y-axis, and the angular rotation about the Z-axis into input signal data into a format that can be executed by said application program.

5. The motion- and attitude-sensing system as recited in claim 1, wherein the application program is selected from the group consisting of three-dimensional map navigation program, a three-dimensional game program, a menu navigation program, and a user interface program and the device is selected from the group comprising portable wireless devices, mobile telephones, cellular telephones, cordless telephones, text messaging devices, pagers, talk radios, portable navigation systems, portable music players, portable video players, portable multimedia devices, personal digital assistants (PDAs), and portable game machines.

6. An electronic device including an application program that is executable thereon, the electronic device comprising:
a motion- and attitude-sensing system including:
a three-axis accelerometer that is adapted to provide a first set of signals associated with a change in attitude of the electronic device; and
a three-axis magnetic field sensor that is adapted to provide a second set of signals associated with a change in attitude of the electronic device.

7. The portable electronic device as recited in claim 6, wherein the application program is selected from the group consisting of a three-dimensional map navigation program, a three-dimensional game program, a menu navigation program, and a user interface program and the device is selected from the group comprising portable wireless devices, mobile telephones, cellular telephones, cordless telephones, text messaging devices, pagers, talk radios, portable navigation systems, portable music players, portable video players, portable multimedia devices, personal digital assistants (PDAs), and portable game machines.

8. A system for generating input signals to an application program that is being executed by an apparatus, the system comprising:
memory for storing the application program, an input signal calculation program, and a calibration program;
an accelerometer that is integrated into the apparatus and adapted to generate continuous signals related to a pitch angle and a roll angle of the apparatus;
a magnetic field sensor that is integrated into the apparatus and adapted to generate continuous signals related to a yaw angle of the apparatus; and
a processor operatively coupled to the memory, the accelerometer, and the magnetic field sensor, the processor being adapted to execute the application program, execute the input signal calculation program, and execute the calibration program using the signals from the accelerometer and the magnetic filed sensor,
wherein the magnetic sensor is a magnetic compass.

9. The apparatus as recited in claim 8, wherein the application program is selected from the group consisting of a three-dimensional map navigation program for a portable electronic devices, a three-dimensional game program, and a menu navigation program associated with a user interface program.

10. The apparatus as recited in claim 8, wherein the apparatus is structured and arranged to include at least one of a wireless communication function, a multimedia function, and a global positioning system (GPS) function.

11. A method for providing input signals corresponding to inertial attitude and/or a change in inertial attitude to an application program for execution on a device, the method comprising:
integrating a two- or three-axis accelerometer and a three-axis magnetic field sensor into the device that executes the application program;
sensing at least one of acceleration and magnetic field strength of the device using the two- or three-axis accelerometer and the three-axis magnetic field sensor;
generating said input signals that are proportional to said acceleration and said magnetic field strength; and
providing said input signals to the application program to change an operation performed by the application program,
wherein the three-axis magnetic field sensor integrated into the device is a magnetic compass.

12. The method as recited in claim 11, wherein the application program is selected from the group comprising a map navigation program, a game program, and a user interface program and the device is selected from the group comprising portable wireless devices, mobile telephones, cellular telephones, cordless telephones, text messaging devices, pagers, talk radios, portable navigation systems, portable music players, portable video players, portable multimedia devices, personal digital assistants (PDAs), and portable game machines.

13. A method for determining the inertial attitude and/or change in inertial attitude of an object in space and for changing an operation performed by an application program executed on the object in space, the method comprising:
integrating a two- or three-axis accelerometer and a three-axis magnetic field sensor into the object;
detecting an inertial attitude and/or an angular velocity of the object using the two- or three-axis accelerometer and the three-axis magnetic sensor;
generating an input signal proportional to said inertial attitude and/or said angular velocity; and
inputting the input signal into the application program,
wherein the three-axis magnetic field sensor integrated into the device is a magnetic compass.

14. The method as recited in claim 5, wherein the application program is selected from the group comprising a map navigation program, a game program, and a user interface program and the device is selected from the group comprising portable wireless devices, mobile telephones, cellular telephones, cordless telephones, text messaging devices, pagers, talk radios, portable navigation systems, portable music players, portable video players, portable multimedia devices, personal digital assistants (PDAs), and portable game machines.

15. A method for providing input signals corresponding to inertial attitude and/or a change in inertial attitude to an application program for execution on a device, the method comprising:
integrating a two- or three-axis accelerometer and a three-axis magnetic filed sensor into the device;
sensing an inertial attitude of the device;
generating an angular velocity signal when the device rotates;
generating an input signal that is proportional to the angular velocity signal; and
providing the input signal to the application program to change an operation performed by said application program,
wherein the three-axis magnetic field sensor integrated into the device is a magnetic compass.

16. A method of generating input signals to an application program that is executable on an electronic device, the method comprising:
integrating a two- or three-axis accelerometer and a three-axis magnetic field sensor into the electronic device;
adapting the two- or three-axis accelerometer to produce a first set of signals that is proportional to a change in attitude of the electronic device;
adapting the three-axis magnetic field sensor to produce a second set of signals that is proportional to a change in attitude of the electronic device;
processing the first and second set of signals;
calculating pitch, roll, and yaw, and angular rotation about an X-axis, a Y-axis, and a Z-axis using the first and second sets of signals; and
translating the pitch, roll, and yaw, and angular rotation about the X-axis, the Y-axis, and the Z-axis into an input signal for the application program,
wherein the three-axis magnetic field sensor integrated into the device is a magnetic compass.
